(19) United States
(12) Patent Application Publication
(10) Pub. No.: US 2010/0029535 A1
(43) Pub. Date: Feb. 4, 2010

(54) Package Comprising a Detergent Composition

(75) Inventors: Daniele FREGONESE, Ludwigshafen (DE); Chris Efstathios Housmekerides, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/576,695

(22) Filed: Oct. 9, 2009

Related U.S. Application Data
(63) Continuation of application No. 10/548,558, filed on Oct. 18, 2005, now abandoned.

(30) Foreign Application Priority Data
Mar. 11, 2003 (GB) 0305493.9
Sep. 22, 2003 (GB) 0322121.5
Oct. 8, 2003 (GB) 0323516.5

(51) Int. Cl. C11D 17/00

(52) U.S. Cl. 510/224; 510/439; 510/296

(57) ABSTRACT

A package comprises a detergent composition enclosed by a water-soluble or water-dispersible packaging material. The detergent composition further comprises encapsulated phthalimidoperhexanoic acid (PAP) in granular form having a particle size of from 10-500 μm.

The present invention relates to a package comprising a detergent composition as well as to a process for preparing such a package.

Bleaches in detergent compositions are well known. Their presence is necessary to treat stains, especially to remove coloured stains from items being washed.

Typically bleaches comprise compounds that produce/release active singlet oxygen in washing liquor. Examples of such bleaches include per-salts such as perborate and percarbonate, also organic carbonates are used.

The bleaches are commonly employed in conjunction with a bleach activator (such as TAED) which increase the activity of the bleach at lower washing temperatures (<40° C.).

There is continual pressure upon detergent manufacturers and retailers to produce new products and especially products which are more cost efficient to manufacture (and sell) than those currently available.

Ways in which to achieve this result is the use of less expensive ingredients or to use the current ingredients at a lower but still effective concentration.

PAP (phthalimidoperhexanoic acid) has been used as a bleach in detergent formulations, e.g. as described in EP-A-0 390 387 and EP-A-0 653 485 and

It has been surprisingly been found that by altering the particle size of the PAP, its efficacy as a bleach is greatly enhanced.

The present invention provides, in a first aspect, a package comprising a detergent composition enclosed by a water-soluble or water-dispersible packaging material, wherein the detergent composition comprises encapsulated phthalimidoperhexanoic acid (PAP) in granular form.

Most preferably the PAP has a particle size of from 10-500 μm.

We have now discovered that PAP is able to provide excellent bleach activity when present in an encapsulate having above granulometry.

Without wishing to be bound by theory it is proposed that the reason for this high activity is a result of the ability of PAP having the particle size above to disperse/dissolve quickly in the wash liquor.

This is particularly important as most automatic washing machines begin their operation cycle at a relatively low temperature before heating up to a higher temperature. This is especially true for automatic dishwashing machines. PAP granules having the particle size above are able to effectively disperse/dissolve before the temperature of the wash liquor is such that the activity of the PAP is compromised (the max activity of PAP is reached at 38.5° C.).

Furthermore the quick dissolution speed means that the PAP may be completely dissolved/dispersed before the remainder of the detergent composition. This is especially relevant where the remainder of the detergent composition is a solid/viscous liquid. As detergent compositions (especially dishwasher detergent compositions) are highly alkali the effect of the dissolution is to alter the pH of the liquor so that it to is highly alkali. Thus PAP having a particle size above is able to dissolve before the majority of the detergent and before the alkalinity of a wash liquor is such that the activity of the PAP is compromised.

Preferably the package is used in the domestic environment for the washing and treatment of clothes and the washing of hard surfaces including glassware and kitchen ware. The composition may typically be used in domestic laundry and dishwashing operations, including in automatic laundry machines and automatic dishwashers. The composition may take the form of a complete detergent or in the alternative may take the form of a separate additive. In the latter case the additive may used for removing stains on crockery/kitchenware in a separate liquor before the items are washed in a dishwasher. The additive can also be used in a liquor together with either a bleach-free washing agent or a bleach-containing washing agent as a bleach booster.

Preferably the PAP has a particle size of 10-300 μm. In this regard it has been observed that a particle size of larger than 10 μm avoids production/manufacturing issues cased by small particle size materials. These problems include adherence to tubing, incorrect/inaccurate dosing. Most preferably the PAP has a particle size of 200-300 μm (e.g. about 250 μm).

The package compartment may, for example, be formed of a film. The film may be a single film, or a laminated film as disclosed in GB-A-2,244,258. While a single film may have pinholes, the two or more layers in a laminate are unlikely to have pinholes which coincide.

The thickness of the film may be up to 2 mm, more preferably up to 1 mm, more preferably 40 to 300 μm, more preferably 60 to 200 μm, especially 60 to 160 μm, more especially 60 to 150 μm and most especially 60 to 150 μm.

The film may be produced by any process, for example by extrusion and blowing or by casting. The film may be unoriented, monoaxially oriented or biaxially oriented. If the layers in the film are oriented, they usually have the same orientation, although their planes of orientation may be different if desired.

The layers in a laminate may be the same or different. Thus they may each comprise the same polymer or a different polymer.

Examples of water-soluble polymers which may be used in a single layer film or in one or more layers of a laminate or which may be used for injection moulding or blow moulding are poly(vinyl alcohol) (PVOH), cellulose derivatives such as hydroxypropyl methyl cellulose (HPMC) and gelatin. An example of a preferred PVOH is ethoxylated PVOH. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a film soluble in cold (ie room temperature) water, whereas 92% hydrolysis corresponds to a film soluble in warm water.

The package may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate package. The amount of vacuum or pressure and the thermoforming temperature used depend on the thickness and porosity of the film and on the polymer or mixture of polymers being used. Thermoforming of PVOH films is known and described in, for example, WO 00/55045.

A suitable forming temperature for PVOH or ethoxylated PVOH is, for example, from 90 to 130° C., especially 90 to 120° c. A suitable forming pressure is, for example, 69 to 138 kPa (10 to 20 p.s.i.), especially 83 to 117 kPa (12 to 17 p.s.i.). A suitable forming vacuum is 0 to 4 kPa (0 to 40 mbar), especially 0 to 2 kPa (0 to 20 mbar). A suitable dwell time is, for example, 0.4 to 2.5 seconds, especially 2 to 2.5 seconds.

While desirably conditions chosen within the above ranges, it is possible to use one or more of these parameters outside the above ranges, although it may be necessary to compensate by changing the values of the other two parameters.

The package may comprise a partially pre-formed container. Preferred examples of such containers include gelatin capsules, such as those employed in medicament applications. When gelatin is used it will be appreciated that the formulation and the physical nature of the gelatin may wary widely. For example the gelatin may be a hard gelatin or a soft gelatin (having a plasticiser component such as water, glycerine, mono-propylene glycol or polyethylene glycol).

The package may be in the form of a solid body. That is to say the package is not in the form of a walled container but instead a shape, which is substantially solid (optionally with pores/apertures). The solid preferably comprises a matrix. The matrix may be formed of the material used for the film of the package or alternatively the matrix may comprise a second material. Preferred matrix forming materials include gelatin, especially in an admixture with glycerine, optionally with water. A further preferred matrix forming material is polyethylene glycol (PEG) having a molecular mass of 3000 or above, e.g. such as 6000, 8000, 20000, 35000 or 8 million.

Generally the package has the dimensions of between 5 and 50 mm. It will be appreciated that the size may vary in accordance with the intended use of the package: when the package is intended for use as a booster it may be relatively small (e.g. around 7-11 mm in diameter) when the package is intended for use a “complete” detergent it may be relatively large (e.g. around 35-45 mm in diameter).

The package is typically spherical.

In case of encapsulation in hard gelatin capsules the package may be completely filled or only partially filled. The composition contained therein may be a particulate or granulated solid. In case of encapsulation in soft gelatin capsules the composition contained therein may be a liquid, which may be thickened or gelled if desired. The liquid composition may be non-aqueous or aqueous, for example comprising less than or more than 5% total or free water. The composition may have more than one phase. For example it may comprise an aqueous composition and a liquid composition which is immiscible with the aqueous composition. It may also comprise a liquid composition and a separate solid composition, for example in the form of a ball, pill or speckles.

Preferably the phthalimidoperhexanoic acid (PAP) comprises from 0.1 to 50%, more preferably from 0.1 to 40%, more preferably 0.1 to 30% more preferably 0.1 to 20% and most preferably 0.1 to 10 wt % of the overall composition.

Preferred particulate forming aids include NaCl, Na₂SO₄, Na₂CO₃, K₂SO₄, K₂CO₃, KCl. It has been found that the use of one or more of these particulate forming aids the long term stability of the PAP. One suggestion for the long term stabilisation effect is that the particulate forming aids maintain the PAP in a desiccated state.

The composition may additionally comprise a builder. In this regard it has been found that the addition of a builder to the first composition greatly enhanced is the activity of the PAP on bleachable stains (such as tea). It is postulated that this enhanced activity rises as the builder is able chelate metal ions (such as calcium iron, or zinc, copper and other ions) which may be present in the dishwasher liquor. These metal ions could otherwise interfere with the performance of the PAP as the metals may allow their oxidation state to be effected by the PAP (and in doing so the PAP is de-activated). Rather than PAP being active on the stains and soil.

These advantages are particularly notable if the builder is present in the first composition as then the builder enters the wash liquor at the same time as the PAP.

Preferably the builder is present in the first composition at an amount of 0.05-5 g, more preferably 0.5 g-1 g, and most preferably 0.5 g-0.6 g.

Alternatively the amount of builder may be expressed relative to the amount of PAP. In this case the ratio of builder to PAP is preferably about 1:1 (on a weight basis).

Preferred builders include nitroloacetic acid (NTA), ethylendamminotetracetate (EDTA), succinic acid, polyaspartic acid, polyglycine, phosphonic acid or an admixture thereof. Most preferably the builders are NTA and phosphonic acid present in a 1:1 weight ratio.

The composition may comprise a carrier fluid. Preferred examples of carrier fluids include hydrophobic oils such as paraffin oil, vegetable oils (e.g. olive oil/sunflower oil), a silicone oil, polyethylene glycol (PEG) (preferably having a molecular weight of from 200 to 4000) or an admixture thereof.

It has been found that where the package contains PEG as a carrier fluid the package finds excellent utility when sold separately as a bleach booster. In a preferred form of this embodiment the compartment comprises a shell of gelatin. Most preferably the PEG comprises an admixture of low and high molecular weight PEG. Preferably the ratio of low to high molecular weight PEG is approximately equal. This admixture has been found to provide a fast dissolution time for the PAP in the wash. Also this mixture is able to dissolve the PAP. Thus preferably the compartment comprises:

(a) A gelatin composition shell

(b) 36% low molecular weight PEG such as (PEG 300)

(c) 24% high molecular weight PEG such as (PEG 3000)

(d) 40% PAP

Preferably the compartment has a weight of from 1-10 most preferably from 1-5 g e.g., such as 2-3 g.

The package optionally comprises one or more additional ingredients. These include conventional detergent composition components, such as surfactants, bleaches, bleach enhancing agents, silver-corrosion inhibiting agents, enzymes, enzyme stabilizers, soil release agents, dye transfer inhibiting agents, brighteners, perfumes, colorants, and dyes.

The package may (as mentioned above) be sold and used separately as a bleach booster. Alternatively the package may find use as a component of a multi-component detergent product. Thus the package may be incorporated within/attached to a second water soluble body containing a detergent composition. Alternatively the package may be incorporated within/attached to a detergent tablet formulation.

Where the multi-component product comprises the package of the first aspect of the invention and a second water soluble body then preferably the package is contained within the second water soluble body.

(Hereafter the term package shall be used to refer to the package of the first aspect of the invention and the term body shall be used to refer to the water soluble body in this embodiment)

The water soluble body preferably comprises a water soluble/dispersible film. The film preferably comprises a polymer such as those discussed above for the package. Clearly the polymer used for the film of the body may be the same or different from that used for the package.

The body may comprise a powder or more preferably a liquid detergent formulation. Most preferably the package is insoluble in the body detergent composition.

This embodiment can have a particularly attractive appearance since it contains two compositions. The compositions can be easily differentiated to accentuate their difference. For example, the compositions can have a different physical appearance, or can be coloured differently. Thus, for example, the containers can have an appearance of a fried egg or eyeball.

The body and the package may contain two components which are incompatible with each other. The package may also contain a component which is incompatible with the film of the body.

It is possible to ensure that the components are released at different times. Thus, for instance, one composition can be released immediately as the body is added to water, whereas the other may be released later as the package becomes dissolved/dispersed.

The body may be formed in any of the ways described above for the package.

The body may comprise a fabric care, surface care or dishwashing composition. Thus, for example, it may be a dishwashing, water-softening, laundry or detergent composition, or a rinse aid. Such compositions may be suitable for use in a domestic dishwashing machine. The composition may also be a disinfectant, antibacterial or antiseptic composition, or a refill composition for a trigger-type spray. Such compositions are generally packaged in amounts of from 5 to 100 g, especially from 15 to 40 g. For example, a dishwashing composition may weigh from 15 to 30 g, a water-softening composition may weigh from 15 to 40 g.

The body composition preferably contains a builder.

The preferred builder material is of the oligocarboxylate or polycarboxylate type, such as compounds selected from the group consisting of sodium citrate, sodium polyacrylate and its copolymers, sodium gluconate and mixtures thereof. Most preferably the builder is an alkali metal (e.g. sodium/potassium) citrate salt.

Optionally the builder material at least partially comprises a phosphorous based builder, as in the tripolyphosphate e.g., potassium tripolyphosphate.

Generally the water content of the body composition is between 20 and 50 wt %. Most preferably the water content is between 30 and 40 wt %.

The body composition may contain a sulphonated polymer. This has been found to be especially beneficial in the removal of spots/flecks from hard surfaces.

The sulphonated polymer preferably comprises a copolymer. Preferably, the copolymer comprises the following monomers:
(I) 50-90% by weight of one or monoethylenically unsaturated C₃-C₆ monocarboxyic acid;
(II) 10-50% by weight of unsaturated sulphonic acid;

Advantageously, the copolymer comprises:
(I) 60-90% by weight of one or monoethylenically unsaturated C₃-C₆ monocarboxylic acid.
(II) 10-40% by weight of unsaturated sulphonic acid;

More advantageously the copolymer comprises.
(I) 77% by weight of one or monoethycally unsaturated C₃-C₆ monocarboxylic acid
(II) 23% by weight of unsaturated sulphonic acid.

The monoethylenically unsaturated C₃-C₆ monocarboxylic acid is preferably (meth)acrylic acid.

The unsaturated sulphonic acid monomer is preferably one of the following: 2-acrylamido methyl-1-propanesultonic acid, 2-methacrylamido-2-methyl-1-propanesulphonic acid, 3-methacrylamido-2-hydroxypropanesulphonic acid, allysulphonic acid, methallysulphonic acid, allyloxybenzenesulphonic acid, methallyloxybenzensulphonic acid, 2-hydroxy-3-(2-propenyloxy)propanesulphonic acid, 2-methyl-2-propene-1-sulphonic acid, styrene sulphonic acid, vinylsulphonic acid, 3-sulphopropyl acrylate, 3-sulphopropyl methacrylate, sulphomethylacrylamid, sulphomethylmethacrylamide, and water soluble salts thereof.

The unsaturated sulphonic acid monomer is most preferably 2-acrylamido-2-propanesulphonic acid (AMPS).

The weight average molecular weight of the copolymer according to the present invention is from 3,000 to 50,000 and preferably from 4,500 to 35,000.

Commercially available examples of the preferred sulphonated polymer are available from Rohm & Haas under the trade names Acusol 587G and Acusol 588G

Where the sulphonated polymer is present the second composition may comprise up to 10 wt % of sulphonated polymer (e.g. such as up to 5 wt % or between 1-2 wt %).

The body composition may comprise TAED (this has been found to enhance the activity of the PAP).

Most preferably the amount of TAED present in the second composition is approximately equal to the amount of PAP in the first composition (on a molar basis).

The body composition can also optionally comprise one or more additional ingredients. These include conventional detergent composition components, such as surfactants, bleaches, bleach enhancing agents, silver-corrosion inhibiting agents, enzymes, enzyme stabilisers, soil release agents, dye transfer inhibiting agents, brighteners, perfumes, colorants, and dyes.

In a second aspect the present invention provides a method of forming a detergent product comprising a package according to the first aspect of the invention and a second water soluble/dispersible body.

It will be understood that the features of the first aspect of the invention shall apply mutatis mutandis to the second aspect of the present invention.

The package most preferably comprises a gelatin capsule.

The body composition is most preferably a liquid formulation.

It has been found that the method of forming the package is particularly advantageous if the following order of assembly is adhered to:—
i) the body compartment is formed;
ii) the package is added to the second compartment;
iii) the body composition is added to the body compartment; and
iv) the body compartment is sealed.

It has been found that if the procedure above is followed then there is little or no splashing of the body composition caused by the addition of the package. This has the advantage that any sealing problems caused by splashing of the body composition on to the exterior of the body compartment/parts are obviated.

Where the multi-component product comprises the package of the first aspect of the invention and a tablet then preferably the package is attached to the tablet. More preferably the package is at least partially inserted into a suitable aperture in a surface of the tablet. Indeed it is most preferable that the package is received in an aperture such that about half of the package protrudes above the surface of the tablet. (A plurality of packages may be attached to a tablet).

Generally the package is attached to the tablet by a glue. Preferred examples of glue suitable in this application include gelatin, sorbitol and PEG having a molecular weight greater than 1000.

The tablet may be extruded or may be in a form produced from compressed particulate components.

The tablet generally comprises one or more general detergent components. These include conventional detergent composition components, such as surfactants, bleaches, bleach enhancing agents, silver-corrosion inhibiting agents, enzymes, enzyme stabilizers, soil release agents, dye transfer inhibiting agents, brighteners, perfumes, colorants, and dyes.

The tablet may comprise one or more separate zones. The zones may be arranged in layers.

Further details and advantages of the invention can be seen from the following examples.

### EXAMPLES

### Packages Enclosed by a Water Dispersible Material

The following formulation was prepared by mixing together the indicated components in the weight proportions indicated to prepare a heavy duty dishwasher liquid.

| | |
|---|---|
| Amylase (Genencor) | 0.3% |
| Properase (Genencor) | 0.6% |
| Sorbitol (70% aqueous solution)(Jubula) | 19% |
| Potassium Tripolyphosphate (Rhodia) | 41% |
| Polyacrylic acid (3V Sigma) | 0.85% |
| Dehardened water | 38.2% |
| Blue Dye (Clariant) | 0.0025% |
| Perfume (Givaudan) | 0.3% |
| Sodium sulphate | 6% |
| Sulphonated Polymer (Acusol 588- Rohm and Haas) | 1.5% |
| Bentzotriazol | 0.2% |

The composition (amounts specified in the Examples) was filled into a container using the following procedure.

A Multivac thermoforming machine operating at 6 cycles/min and at ambient conditions of 25° C. and 35% RH (5% RH) was used to thermoform an anhydrous PVOH film. The PVOH film was prepared by a blown process from granules provided by PVAXX® ref C120 having a degree of hydrolysis of 88% and a thickness of 110 μm. When formed the PVOH has a negligible water content. The PVOH film was wrapped in a sealed polyethylene container which remained sealed until immediately prior to use. The PVOH film was thermoformed into a rectangular mould of 39 mm length, 29 mm width and 16 mm depth, with the bottom edges being rounded to a radius of 10 mm, at 125-148° C. The thus formed pocket was filled with 18.66 g of the composition, afterwards a gelatin pill (10.8 mm diameter) containing phthalimidoperhexanoic acid (PAP) (amounts specified in the Examples) is dropped in the open capsule and an identical film was placed on top and heat sealed at 154-162° C. The thus produced containers were separated from each other by cutting the flanges. Each container was rounded and had a full appearance. After a few hours they attained an even more attractive, rounded appearance.

### Comparative Example 1

In Comparative Example 118.66 g of the heavy duty dishwasher liquid was added to the pouch and a PAP containing gelatin capsule (0.6 g PAP) was also added.

In Comparative Example 1 the particle size of the PAP was outside the scope of the invention (varying between 300-1100 μm, with an average greater than 750 μm.

### Examples 1-4

In Example 118.66 g of the heavy duty dishwasher liquid was added to the pouch and a PAP containing gelatin capsule (0.6 g PAP particle size 250 μm) was also added.

Examples 2 and 3 were the same as Example 1 save that the particle size of the PAP was 200 μm and 500 μm respectively.

Example 4 was the same as Example 1; the particle size of the PAP was 250 μm, the gelatin capsule also contained 0.3 g of phosphonic acid (Trilon supplied by BASF) and 0.3 g NTA (BASF).

### APPLICATION EXAMPLES

### Application Example 1

The bleach capability (and other cleaning capabilities) was tested in a General Electrics GSD5130D03WW dishwashing machine using a 55° C. cycle, according to the method IKW. In each case a container comprising the formulation was added at the start of the dishwasher main wash cycle. The water hardness was 9° gH. The results (given in Table 1) are expressed on a scale of 0-10 (0 being worst and 10 being best).

TABLE 1

Formulation

| Stain | Ex. 1 | Ex. 2 | Ex. 3 | Comp. 1 |
|---|---|---|---|---|
| Bleachable (Tea) | 9.1 | 9.2 | 8.6 | 7.6 |
| Starch | 9.4 | 9.3 | 9.4 | 9.3 |
| Protein | 6.7 | 6.7 | 6.8 | 6.8 |
| Burnt-on (milk) | 7.5 | 7.5 | 7.8 | 7.5 |
| | Av. 8.2 | Av. 8.2 | Av. 8.1 | Av. 7.8 |

The results show that when the PAP is present in the capsule at a particle size of 200 to 500 μm the best bleaching cleaning results are obtained. Additionally these results are obtained without any detrimental affect upon any of the other cleaning properties.

### Application Example 2

The bleach capability (and other cleaning capabilities) was tested in a Bosch SMS 5062 dishwashing machine using a 50° C. cycle, according to the method IKW. In each case a container comprising the formulation was added at the start of the dishwasher main wash cycle. The water hardness was 21° gH. The results (given in Table 2) are expressed on a scale of 0-10 (0 being worst and 10 being best).

TABLE 2

Formulation

| Stain | Ex. 1 | Ex. 4 |
|---|---|---|
| Bleachable (Tea) | 3.0 | 3.9 |
| Starch | 8.7 | 8.7 |
| Protein | 3.1 | 2.5 |
| Burnt-on (milk) | 6.6 | 6.5 |
| | Av. 5.3 | Av. 5.4 |

The results show that when the PAP is present in the capsule at a particle size of 250 μm in combination with the chelating agents (as specified above) the best bleaching cleaning results are obtained at high water hardness. Additionally these results are obtained without any detrimental affect upon any of the other cleaning properties.

### Tablets

A commercial dishwashing tablet formulation was prepared and formed into a tablet shape having an aperture suitable for receiving a spherical insert.

The insert had a formulation as specified in the following Comparative Example and Example.

### Tablet Comparative Example 1

The insert weighed 0.8 g and comprised the following components:—

| | |
|---|---|
| Polyethylene Glycol (35000S) | 56% |
| Non-ionic Surfactant (EO/PO RA 30) | 44% |
| Fragrance | Trace |
| Dye | Trace |

### Tablet Example 1

The insert had the same formulation as for Comparative Example 1 save that the insert included 0.6 g PAP with an average particle size of 250 μm.

### TABLET APPLICATION EXAMPLES

### Tablet Application Example 1

The following detergent composition was used for the tablet form.

### Tablet Composition

| Component | % |
|---|---|
| Sodium Tripolyphosphate | 45.0 |
| Sodium Bicarbonate | 2.0 |
| Sodium Carbonate | 18.5 |
| Sodium Perborate | 10.0 |
| TAED | 2.5 |
| Protease | 1.5 |
| Amylase | 0.5 |
| Non-ionic Surfactant | 3.5 |
| Polyethylene-glycol) | 7.5 |
| Perfume + Dye | 0.3 |
| Auxiliaries | Rest |

The bleach capability (and other cleaning capabilities) was tested in a General Electrics GSD5130D03WW dishwashing machine using a 55° C. cycle, according to the method IKW. In each case a container comprising the formulation was added at the start of the dishwasher main wash cycle. The water hardness was 9° gH. The results (given in Table 3) are expressed on a scale of 0-10 (0 being worst and 10 being best).

TABLE 3

Formulation

| Stain | Ex. 1 | Comp. 1 |
|---|---|---|
| Bleachable (Tea) | 9.4 | 6.2 |
| Starch | 9.2 | 9.0 |
| Protein | 5.2 | 5.2 |
| Burnt-on (milk) | 6.6 | 6.6 |
| | Av. 7.6 | Av. 6.7 |

The results show that when the PAP is present in the insert at a particle size of 250 μm excellent bleaching cleaning results are obtained. Additionally these results are obtained without any detrimental affect upon any of the other cleaning properties.

1. A package comprising a detergent composition enclosed by a water-soluble or water-dispersible packaging material, wherein the detergent composition comprises encapsulated phthalimidoperhexanoic acid (PAP) in granular form, wherein the PAP has a particle size of from 10-500 μm.

2. A package according to claim 1, wherein the package compartment is formed of a film.

3. A package according to claim 2, wherein the thickness of the film is up to 2 mm.

4. A package according to claim 1, wherein the package comprises a pre-formed container.

5. A package according to claim 4, wherein the container is a gelatin capsule.

6. A package according to claim 1, wherein the package is in the form of a solid body.

7. A package according to claim 1, wherein the phthalimidoperhexanoic acid (PAP) comprises from 0.1 to 50%, of the detergent composition.

8. A package according to claim 1, wherein the composition comprises a builder.

9. A package according to claim 9, wherein the builder is selected from: nitroloacetic acid (NTA), ethylendamminotetracetate (EDTA), succinic acid, polyaspartic acid, polyglycine, phosphonic acid or an admixture thereof.

10. A package according to claim 1, wherein the composition comprises a carrier fluid.

11. A detergent product comprising a package according to claim 1.

12. A detergent product, wherein the product comprises a water soluble or water dispersible body containing a detergent composition having a package according to claim 1 contained therein or attached thereto.

13. A detergent product according to claim 12, wherein the product comprises a detergent tablet having a package according to claim 1 contained therein or attached thereto.

14. Use of a product or package according to claim 1 for the washing and treatment of clothes and the washing of hard surfaces e.g. glassware and kitchen ware.

15. A package according to claim 3, wherein the thickness of the film is up to 1 mm.

16. A package according to claim 15, wherein the thickness of the film is up to 40 to 300 μm.

17. A package according to claim 16, wherein the thickness of the film is 60 to 200 μm.

18. A package according to claim 17, wherein the thickness of the film is 60 to 150 μm.

19. A package according to claim 7 wherein the phthalimidoperhexanoic acid (PAP) comprises from 0.1 to 40% of the detergent composition.

20. A package according to claim 19 wherein the phthalimidoperhexanoic acid (PAP) comprises from 0.1 to 30% of the detergent composition.
